(19) United States
(12) Patent Application Publication
(10) Pub. No.: US 2026/0289283 A1
(43) Pub. Date: Sep. 24, 2026

(54) METHOD, AN APPARATUS AND A COMPUTER PROGRAM PRODUCT FOR NEURAL NETWORK COMPRESSION

(71) Applicant: Nokia Technologies Oy, Espoo (FI)

(72) Inventors: Goutham RANGU, Tampere (FI); Hamed REZAZADEGAN TAVAKOLI, Espoo (FI)

(21) Appl. No.: 19/571,233

(22) Filed: Mar. 18, 2026

Related U.S. Application Data
(60) Provisional application No. 63/775,070, filed on Mar. 20, 2025.

(51) Int. Cl. G06N 3/0495

(52) U.S. Cl. CPC G06N 3/0495

(57) ABSTRACT

The embodiments relate to an apparatus and a method for encoding and decoding. The encoding method comprises receiving a neural network model to be compressed; processing the neural network model to obtain a compressed representation of the neural network model, the compressed representation being in form of a tensor having one or more dimensions; performing a local scaling adaptation on an axis of the tensor to result in a compressible tensor and a scaling vector; encoding at least the compressible tensor into a bitstream; encoding into the bitstream a presence of a local scaling adaptation; and encoding information into the bitstream, the information indicating an axis of the tensor to which the local scaling adaptation was applied. The decoding method comprises inverse steps of the encoding.

### TECHNICAL FIELD

The present solution generally relates to neural network compression.

### BACKGROUND

This section is intended to provide a background or context to the invention that is recited in the claims. The description herein may include concepts that could be pursued but are not necessarily ones that have been previously conceived or pursued. Therefore, unless otherwise indicated herein, what is described in this section is not prior art to the description and claims in this application and is not admitted to be prior art by inclusion in this section.

Neural network is widely used example of machine learning. The operation of neural network—as well as other machine learning models—is based on training. A neural network is able to configure itself based on training data, which is input to the system. After training, the neural network makes predictions and/or decisions over the received input according to its configuration.

Neural networks are utilized for a broad range of tasks in multimedia analysis and processing, media coding, data analytics and many other fields. Trained neural networks contain a large number of parameter and weights, resulting in a relatively large size. Therefore, the trained neural networks or their weights updates should be represented in a compressed form.

### SUMMARY

The scope of protection sought for various embodiments of the invention is set out by the independent claims. The embodiments and features, if any, described in this specification that do not fall under the scope of the independent claims are to be interpreted as examples useful for understanding various embodiments of the invention.

Various aspects include a method, an apparatus and a computer readable medium comprising a computer program stored therein, which are characterized by what is stated in the independent claims. Various embodiments are disclosed in the dependent claims.

According to a first aspect, there is provided an apparatus for encoding, the apparatus comprising at least one processor, memory including computer program code, the memory and the computer program code configured to, with the at least one processor, cause the apparatus to perform at least the following: receive a neural network model to be compressed; process the neural network model to obtain a compressed representation of the neural network model, the compressed representation being in form of a tensor having one or more dimensions; perform a local scaling adaptation on an axis of the tensor to result in a compressible tensor and a scaling vector; encode at least the compressible tensor into a bitstream; encode into the bitstream a presence of a local scaling adaptation; and encode information into the bitstream, the information indicating an axis of the tensor to which the local scaling adaptation was applied.

According to a second aspect, there is provided a method for encoding, comprising receiving a neural network model to be compressed; processing the neural network model to obtain a compressed representation of the neural network model, the compressed representation being in form of a tensor having one or more dimensions; performing a local scaling adaptation on an axis of the tensor to result in a compressible tensor and a scaling vector; encoding at least the compressible tensor into a bitstream; encoding into the bitstream a presence of a local scaling adaptation; and encoding information into the bitstream, the information indicating an axis of the tensor to which the local scaling adaptation was applied.

According to a third aspect, there is provided an apparatus comprising means for receiving a neural network model to be compressed; means for processing the neural network model to obtain a compressed representation of the neural network model, the compressed representation being in form of a tensor having one or more dimensions; means for performing a local scaling adaptation on an axis of the tensor to result in a compressible tensor and a scaling vector; means for encoding at least the compressible tensor into a bitstream; means for encoding into the bitstream a presence of a local scaling adaptation; and means for encoding information into the bitstream, the information indicating an axis of the tensor to which the local scaling adaptation was applied.

According to a fourth aspect, there is provided a computer program product comprising computer program code configured to, when executed on at least one processor, cause an apparatus or a system to: receive a neural network model to be compressed; process the neural network model to obtain a compressed representation of the neural network model, the compressed representation being in form of a tensor having one or more dimensions; perform a local scaling adaptation on an axis of the tensor to result in a compressible tensor and a scaling vector; encode at least the compressible tensor into a bitstream; encode into the bitstream a presence of a local scaling adaptation; and encode information into the bitstream, the information indicating an axis of the tensor to which the local scaling adaptation was applied.

According to a fifth aspect, there is provided an apparatus comprising at least one processor, memory including computer program code, the memory and the computer program code configured to, with the at least one processor, cause the apparatus to perform at least the following: receive a encoded bitstream; decode a tensor from the bitstream; detect a presence of a local scaling adaptation from the bitstream; determine an axis from the bitstream, which axis the local scaling adaptation is applied to; reconstruct parameters for a neural network by applying the local scaling adaptation to the determined axis of the tensor; and generate the neural network according to the reconstructed parameters.

According to a sixth aspect, there is provided a method for decoding, comprising receiving a encoded bitstream; decoding a tensor from the bitstream; detecting a presence of a local scaling adaptation from the bitstream; determining an axis from the bitstream, which axis the local scaling adaptation is applied to; reconstructing parameters for a neural network by applying the local scaling adaptation to the determined axis of the tensor; and generating the neural network according to the reconstructed parameters.

According to a seventh aspect, there is provided an apparatus comprising at least means for receiving a encoded bitstream; decoding a tensor from the bitstream; means for detecting a presence of a local scaling adaptation from the bitstream; means for determining an axis from the bitstream, which axis the local scaling adaptation is applied to; means for reconstructing parameters for a neural network by applying the local scaling adaptation to the determined axis of the tensor; and means for generating the neural network according to the reconstructed parameters.

According to an eighth aspect, there is provided a computer program product comprising computer program code configured to, when executed on at least one processor, cause an apparatus or a system to: receive a encoded bitstream; decode a tensor from the bitstream; detect a presence of a local scaling adaptation from the bitstream; determine an axis from the bitstream, which axis the local scaling adaptation is applied to; reconstruct parameters for a neural network by applying the local scaling adaptation to the determined axis of the tensor; and generate the neural network according to the reconstructed parameters.

According to an embodiment for any of the previous aspects, the information indicates that the local scaling adaptation parameter is employed only on first axis or on last axis of a tensor.

According to an embodiment for the previous embodiment, a flag is encoded into or decoded from the bitstream to indicate an axis to be processed.

According to an embodiment for any of the previous aspects, the information indicates that the local scaling adaptation parameter is employed on any axis of a tensor.

According to an embodiment for the previous embodiment, a number of the axis to be processed is encoded into or decoded from the bitstream.

According to an embodiment for any of the previous aspects or embodiments, the scaling vector is kept uncompressed.

According to an embodiment for any of the previous aspects or embodiments, the bitstream is send to a decoder or received from an encoder.

According to an embodiment, the computer program product is embodied on a non-transitory computer readable medium.

### DESCRIPTION OF THE DRAWINGS

In the following, various embodiments will be described in more detail with reference to the appended drawings, in which

FIG. 1 shows an example of a convolutional neural network;

FIG. 2 shows an example of a neural network compression pipeline;

FIG. 3 shows an example of a neural network compression pipeline according to present embodiments;

FIG. 4 shows an example of a neural network decompression pipeline according to present embodiments;

FIG. 5 is a flowchart illustrating a method for encoding according to an embodiment;

FIG. 6 is a flowchart illustrating a method for decoding according to an embodiment;

FIG. 7 shows an apparatus according to an embodiment; and

FIG. 8 shows an example of a multimedia communication system within which various embodiments may be implemented.

### DETAILED DESCRIPTION OF THE DRAWINGS

The following description and drawings are illustrative. The specific details are provided for a thorough understanding of the disclosure. However, in certain instances, well-known or conventional details are not described in order to avoid obscuring the description. References to one or an embodiment in the present disclosure can be, but not necessarily are, reference to the same embodiment and such references mean at least one of the embodiments.

Reference in this specification to “one embodiment” or “an embodiment” means that a particular feature, structure, or characteristic described in connection with the embodiment in included in at least one embodiment of the disclosure. Also, in the specification, terms “model” and “neural network” are used interchangeably and also the term “weight” may be referred to as “learnable parameter” or as “parameter”.

MPEG (Moving Picture Experts Group) is currently pursuing standardization of neural network compression (NNC) also known as neural network representation compression (NNR).

A neural network (NN) is a computation graph consisting of several layers of computation. Each layer consists of one or more units, where each unit performs an elementary computation. A unit is connected to one or more other units, and the connection may have associated with a weight. The weight may be used for scaling the signal passing through the associated connection. Weights are learnable parameters, i.e., values which can be learned from training data. There may be other learnable parameters, such as those of batch-normalization layers.

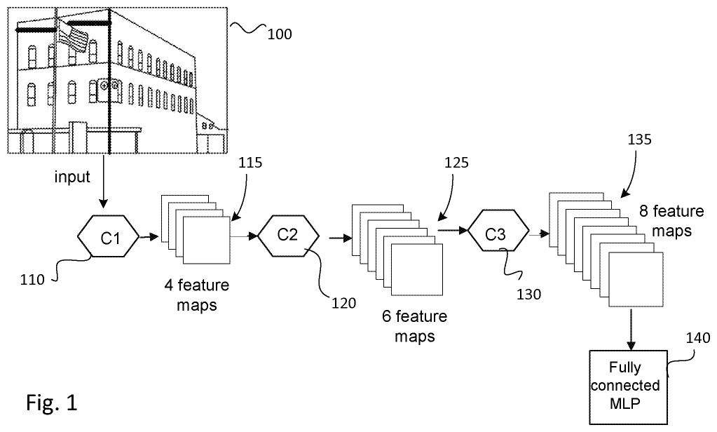

FIG. 1 shows an example of a neural network, a Convolutional Neural Network (CNN). This example of a CNN comprises one or more convolutional layers, fully connected layers, and a classification layer on top. CNNs are relatively easy to train compared to other deep neural networks and have fewer parameters to be estimated. Therefore, CNNs are highly attractive architecture to use, especially in image and speech applications.

In the example of FIG. 1, the input 100 to a CNN is an image, but any other data could be used as well. Each layer of a CNN represents a certain abstraction (or semantic) level, and the CNN extracts multiple feature maps. A feature map may for example comprise a dense matrix of Real numbers representing values of the extracted features. The CNN in FIG. 1 has only three feature (or abstraction, or semantic) layers 110, 120, 130 for the sake of simplicity, but CNNs may have more than three convolution layers.

The first convolution layer 110 of the CNN may comprise extracting 4 feature-maps 115 from the first layer (i.e. from the input image). These maps may represent low-level features found in the input image, such as edges and corners. The second convolution layer 120 of the CNN which may extract 6 feature-maps 125 from the previous layer, increases the semantic level of the extracted features. Similarly, the third convolution layer 130 may extract 8 feature-maps 135 from the previous layer may represent more abstract concepts found in images, such as combinations of edges and corners, shapes, etc. The last layer of the CNN, referred to as fully connected Multi-Layer Perceptron (MLP) 140 may include one or more fully connected (i.e., dense) layers and a final classification layer. The MLP 140 uses the feature-maps 135 from the last convolution layer 130 in order to predict (recognize) for example the object class. For example, it may predict that the object in the image is a house.

Two of the most widely used architectures for neural networks are feed-forward and recurrent architectures. Feed-forward neural networks are such that there is no feedback loop: each layer takes input from one or more of the layers before and provides its output as the input for one or more of the subsequent layers. Also, units inside a certain layer take input from units in one or more preceding layers, and provide output to one or more of following layers.

Initial layers (those close to the input data) extract semantically low-level features, such as edges and textures in images, and intermediate and final layers extract more high-level features. After the feature extraction layer there may be one or more layers performing a certain task, such as classification, semantic segmentation, object detection, denoising, style transfer, super-resolution, etc. In recurrent neural networks, there is a feedback loop, so that the neural network becomes stateful, i.e., it is able to memorize information or a state.

Neural networks are being utilized in an ever-increasing number of applications for many different types of device, such as mobile phones. Examples include image and video analysis and processing, social media data analysis, device usage data analysis, etc.

The most important property of neural networks (and other machine learning tools) is that they are able to learn properties from input data, either in supervised way or in unsupervised way. Such learning is a result of a training algorithm, or of a meta-level neural network providing the training signal. In general, the training algorithm consists of changing some properties of the neural network so that its output is as close as possible to a desired output. For example, in the case of classification of objects in images, the output of the neural network can be used to derive a class or category index which indicates the class or category that the object in the input image belongs to. Training may happen by minimizing or decreasing the output's error, also referred to as the loss. Examples of losses are mean squared error, cross-entropy, etc. In recent deep learning techniques, training is an iterative process, where at each iteration the algorithm modifies the weights of the neural network to make a gradual improvement of the network's output, i.e., to gradually decrease the loss.

Training a neural network is an optimization process, but the final goal is different from the typical goal of optimization. In optimization, the only goal is to minimize a function. In machine learning, the goal of the optimization or training process is to make the neural network learn the properties of the data distribution from a limited training dataset. In other words, the goal is to learn to use a limited training dataset in order to learn to generalize to previously unseen data, i.e., data which was not used for training the model. This may be referred as “generalization”. In practice, data may be split into at least two sets, the training set and the validation set. The training set is used for training the neural network, i.e., to modify its learnable parameters in order to minimize the loss. The validation set is used for checking the performance of the network on data, which was not used to minimize the loss, as an indication of the final performance of the neural network. In particular, the errors on the training set and on the validation set are monitored during the training process to understand the following things:
if the network is learning at all—in this case, the training set error should decrease, otherwise the model is in the region of underfitting.
if the network is learning to generalize—in this case, also the validation set error needs to decrease and to be not too much higher than the training set error. If the training set error is low, but the validation set error is much higher than the training set error, or it does not decrease, or it even increases, the model is in the regime of overfitting This means that the model has just memorized the training set's properties and performs well only on that set, but performs poorly on a set not used for tuning its parameters.

Lately, neural networks have been used for compressing and de-compressing data such as an image, i.e., in an image codec. The most widely used architecture for realizing one component of an image codec is the auto-encoder, which is a neural network consisting of two parts: a neural encoder and a neural decoder. Neural encoder takes as input an image and produces a code which requires less bits than the input image. This code may be obtained by applying a binarization or quantization process to the output of the neural encoder. The neural decoder takes in this code and reconstructs the image which was input to the neural encoder.

In the context of machine learning, and neural networks, tensors are being discussed. Tensor refers to a multidimensional array having a shape, a size and a dimension. Tensor is a basic building block used to represent data. Tensor shape is a layout or structure of the tensor, which defines the number of dimensions and sizes of each dimension in the tensor. The shape describes how many elements are along each axis of the tensor. The size of the tensor refers to the total number of elements in a tensor, i.e., total amount of data stored in the tensor. Tensor dimension refers to a length along a particular axis of a tensor, i.e., the extent of a tensor along a specific direction. Each axis of a tensor corresponds to a dimension.

Tensors appear in neural networks, for example, in the following manner: In an example relating to video coding, a neural encoder may take a video as input and convert the video from its original signal space into a latent representation that may comprise a more compressible representation of the input. In the case of an input image, the latent representation may be a 3-dimensional tensor, where two dimensions represent the vertical and horizontal spatial dimensions, and the third dimension represent the “channels” which contain information at that specific location. In the case of an input video (instead of just an input image), yet another dimension in the input tensor may be used to represent temporal information. In video encoding, the latent representation is quantized into discrete values given a predefined set of quantization levels. Probability model and arithmetic codec component work together to perform lossless compression for the quantized latent representation and generate bitstreams to be sent to the decoder side. On the neural decoder side, opposite operations are performed. First, elements from the bitstream are decoded to recover the quantized latent representation. Then, a dequantizer is configured to reconstruct the latent representation in continuous values and pass it to a neural decoder to recover the input video/image.

Such neural encoder and neural decoder may be trained to minimize a combination of bitrate and distortion, where the distortion may be based on one or more of the following metrics: Mean Squared Error (MSE), Peak Signal-to-Noise Ratio (PSNR), Structural Similarity Index Measure (SSIM), or similar. The distortion metrics may be meant to be correlated to the human visual perception, or machine consumption. Minimizing or maximizing one or more of these distortion metrics results into improving the quality of the decoded image for the consumption.

ISO/IEC 15938-17 specifies Neural Network Coding (NNC) as a compressed representation of the parameters (also referred to as “weights”) of a trained neural network and a decoding process for the compressed representation, complementing the description of the topology in existing formats for neural networks. Term “weight compression” relates to compression of model (i.e., neural network) weights.

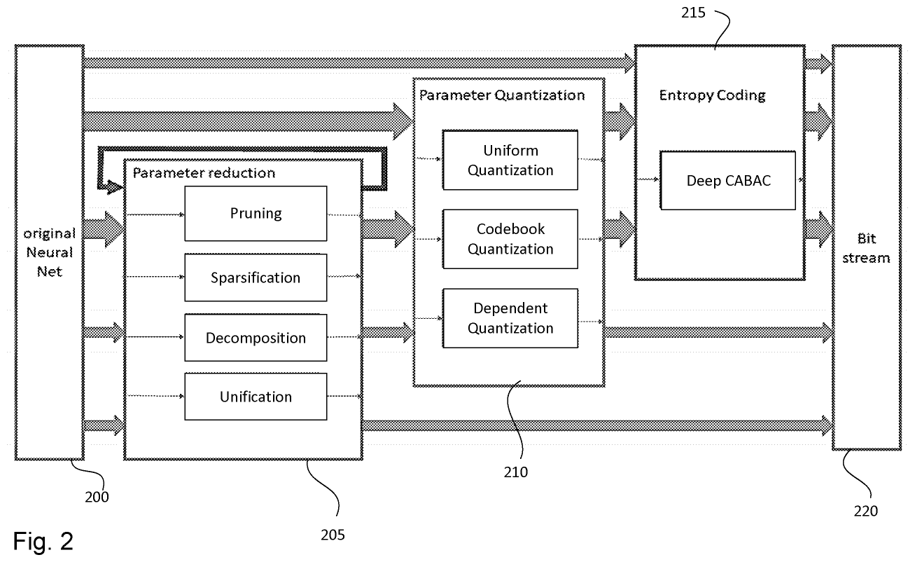

FIG. 2 illustrates an example of NNC encoding pipelines for weight compression that can be assembled using various compression tools. From the group of parameter transformation tools, multiple tools can be applied in sequence. Parameter quantization can be applied to source models as well as to the outputs of transformation with parameter reduction methods. Entropy coding may be applied to the output of quantization. Raw outputs of earlier steps without applying entropy coding can be serialized if needed.

FIG. 2 shows parameter reduction methods 201, comprising (parameter) pruning, (parameter) sparsification, decomposition and (weight) unification. In pruning, the number of parameters is reduced by eliminating parameter or group of parameters. The pruning results in a dense representation which has less parameters in comparison to the original model e.g., by removing some redundant convolution filters from the layers. In sparsification, parameters or group of parameters are processed to produce a sparse representation of a model, e.g., by replacing some weight values with zeros. In decomposition, a matrix decomposition operation is performed to change the structure of the weights of the model. In unification, parameters are processed to produces a group of similar parameters. Unification may not eliminate or constrain the weights to be zero. The entropy of model parameters is however lowered by making them similar to each other. The different parameter reduction methods 201 can be combined or applied in sequence to produce a compact model.

Parameter quantization methods 202 reduce the precision of the representation of weights. If supported by the inference engine, the quantized representation can be used for more efficient inference. The parameter quantization methods may comprise a uniform quantization, a codebook quantization and dependent (scalar) quantization.

Entropy coding methods 204 are configured to encode the results of parameter quantization methods. An example of an entropy coding method is a Deep CABAC.

### MPEG Compression of Neural Network Representation (NNR) Standardization

The high-level syntax included in the NNC comprises a basic structure for the organization of the bitstream. According to this structure, the NNC bitstream is split into elemental units termed NNR Units. The NNR Unit represents a basic high-level syntax structure, and contains three syntax elements: NNR Unit Size, NNR Unit Header, NNR Unit Payload. A bitstream is formed by concatenating several NNR data units (DU). NNR DUs may contain different types of data. The type of data that is contained in the payload of an NNR Unit defines the NNR Unit's type. This type is specified in the NNR Unit Header. Table 1 specifies the NNR unit header types and their identifiers.

TABLE 1

| | | NNR Unit |
|---|---|---|
| | | Header |
| | | Type |
| NNR Unit type | Description | identifier |
| Model parameter set | NN level global metadata | NNR_MPS |
| DU | | |
| Layer parameter set | Layer level metadata | NNR_LPS |
| DU | | |
| NN Topology or | NN topology or graph information | NNR_TPL |
| graph DU | (can be in non-MPEG format) | |
| NN Quantization DU | Quantization information | NNR_QNT |
| NNR Compressed | NNR compressed NN data | NNR_NDU |
| DU | | |
| NNR Compressed | NN compressed bitstream start | NNR_STR |
| NN data start unit | indicator | |
| Aggregate DU | NNR unit that contains a set of | NNR_AGG |
| | NNR DU's | |

There is no detailed structure regarding the content and bitstream syntax of each of these NNR data units. One of the aims of the present embodiments, is to provide bitstream syntax definitions for some of these NNR Units.

### Neural Network Exchange Formats

Several efforts have been made in recent years to provide unified or standardized formats to exchange neural networks among different runtime platforms (Linux, Windows, Android, iOS, etc.), different deep learning frameworks (TensorFlow, Pytorch, etc.) and different languages (Python, C++, Java, etc.). Among these efforts, two are of notable interest: NNEF and ONNX. However, these exchange formats target general neural networks and are not optimized for compressed neural networks.

### Neural Network Exchange Format (NNEF)

NNEF is a standard for the representation of neural networks developed by Khronos members. Its purpose is to define a format that encapsulates network structure and network data. To this end, it specifies a Network Structure File and Network Data files.
Network Structure File: The network structure is in human-readable format.
Network Data File: the weights and other data of the network is represented in binary format. Separate data files are used for different parts of the network (i.e., for different “variables”).
   The Network Data File supports floating-point and quantized data.
   Quantization algorithms are expressed as extensible compound operations.
   The container format is not part of the NNEF specification, however, it is recommended to use the IEEE 1003.1-2008 tar archive with optional compression
      Open Neural Network eXchange (ONNX)

ONNX is an open ecosystem for interchangeable models that is developed by community of partners. ONNX facilitates mechanism for defining deep learning neural networks as computation over dataflow graphs. It, thus, provides the foundations required for the definition of
Extensible computation graph model
Standard data types
Built-in operators

The model file associates metadata with a graph, and it's used when first reading the model file to understand whether the runtime environment is able to run the model (e.g., checking whether all operators are supported).

The data is stored in a file format which is based on Protocol Buffers (PB). PB is language and platform independent serialization mechanism (but not human-readable). Network's data is stored in .proto or .proto3 files. Data in these files is stored as “messages”. These files are then compiled into language-specific classes. By using such classes and the model definition (which is stored in a .onnx file), a platform can then run the model.

### ISO Base Media File Format

Available media file format standards include ISO base media file format (ISO/IEC 14496-12, which may be abbreviated ISOBMFF), MPEG-4 file format (ISO/IEC 14496-14, also known as the MP4 format), file format for NAL (Network Abstraction Layer) unit structured video (ISO/IEC 14496-15) and 3GPP file format (3GPP TS 26.244, also known as the 3GP format). ISOBMFF is the base for derivation of all the above mentioned file formats (excluding the ISOBMFF itself).

Some concepts, structures, and specifications of ISOBMFF are described below as an example of a container file format, based on which the embodiments may be implemented. The aspects of the invention are not limited to ISOBMFF, but rather the description is given for one possible basis on top of which the invention may be partly or fully realized.

A basic building block in the ISO base media file format is called a box. Each box has a header and a payload. The box header indicates the type of the box and the size of the box in terms of bytes. A box may enclose other boxes, and the ISO file format specifies which box types are allowed within a box of a certain type. Furthermore, the presence of some boxes may be mandatory in each file, while the presence of other boxes may be optional. Additionally, for some box types, it may be allowable to have more than one box present in a file. Thus, the ISO base media file format may be considered to specify a hierarchical structure of boxes.

According to the ISO base media file format, a file includes media data and metadata that are encapsulated into boxes. Each box is identified by a four character code (4CC) and starts with a header which informs about the type and size of the box.

In files conforming to the ISO base media file format, the media data may be provided in one or more instances of MediaDataBox (‘mdat’) and the MovieBox (‘moov’) may be used to enclose the metadata for timed media. In some cases, for a file to be operable, both of the ‘mdat’ and ‘moov’ boxes may be required to be present. The ‘moov’ box may include one or more tracks, and each track may reside in one corresponding TrackBox (‘trak’). Each track is associated with a handler, identified by a four-character code, specifying the track type. Video, audio, and image sequence tracks can be collectively called media tracks, and they contain an elementary media stream. Other track types comprise hint tracks and timed metadata tracks.

Tracks comprise samples, such as audio or video frames. For video tracks, a media sample may correspond to a coded picture or an access unit. A media track refers to samples (which may also be referred to as media samples) formatted according to a media compression format (and its encapsulation to the ISO base media file format). A hint track refers to hint samples, containing cookbook instructions for constructing packets for transmission over an indicated communication protocol. A timed metadata track may refer to samples describing referred media and/or hint samples.

Movie fragments may be used e.g. when recording content to ISO files e.g., in order to avoid losing data if a recording application crashes, runs out of memory space, or some other incident occurs. Without movie fragments, data loss may occur because the file format may require that all metadata, e.g., the movie box, be written in one contiguous area of the file. Furthermore, when recording a file, there may not be sufficient amount of memory space (e.g., random access memory RAM) to buffer a movie box for the size of the storage available, and re-computing the contents of a movie box when the movie is closed may be too slow. Moreover, movie fragments may enable simultaneous recording and playback of a file using a regular ISO file parser. Furthermore, a smaller duration of initial buffering may be required for progressive downloading, e.g., simultaneous reception and playback of a file when movie fragments are used and the initial movie box is smaller compared to a file with the same media content but structured without movie fragments.

The movie fragment feature may enable splitting the metadata that otherwise might reside in the movie box into multiple pieces. Each piece may correspond to a certain period of time of a track. In other words, the movie fragment feature may enable interleaving file metadata and media data. Consequently, the size of the movie box may be limited and the use cases mentioned above be realized.

In some examples, the media samples for the movie fragments may reside in an ‘mdat’ box. For the metadata of the movie fragments, however, a ‘moof’ box may be provided. The ‘moof’ box may include the information for a certain duration of playback time that would previously have been in the ‘moov’ box. The ‘moov’ box may still represent a valid movie on its own, but in addition, it may include an ‘mvex’ box indicating that movie fragments will follow in the same file. The movie fragments may extend the presentation that is associated to the ‘moov’ box in time.

Within the movie fragment there may be a set of track fragments, including anywhere from zero to a plurality per track. The track fragments may in turn include anywhere from zero to a plurality of track runs, each of which document is a contiguous run of samples for that track (and hence are similar to chunks). Within these structures, many fields are optional and can be defaulted. The metadata that may be included in the ‘moof’ box may be limited to a subset of the metadata that may be included in a moov box and may be coded differently in some cases. Details regarding the boxes that can be included in a ‘moof’ box may be found from the ISOBMFF specification.

A self-contained movie fragment may be defined to consist of a ‘moof’ box and an mdat box that are consecutive in the file order and where the ‘mdat’ box contains the samples of the movie fragment (for which the ‘moof’ box provides the metadata) and does not contain samples of any other movie fragment (i.e., any other ‘moof’ box).

A media segment may comprise one or more self-contained movie fragments. A media segment may be used for delivery, such as streaming, e.g., in MPEG-DASH.

The track reference mechanism can be used to associate tracks with each other. The TrackReferenceBox includes box(es), each of which provides a reference from the containing track to a set of other tracks. These references are labelled through the box type (i.e., the four-character code of the box) of the contained box(es).

The ISO Base Media File Format contains three mechanisms for timed metadata that can be associated with particular samples: sample groups, timed metadata tracks, and sample auxiliary information. Derived specification may provide similar functionality with one or more of these three mechanisms.

A sample grouping in the ISO base media file format and its derivatives, such as the AVC file format and the SVC file format, may be defined as an assignment of each sample in a track to be a member of one sample group, based on a grouping criterion. A sample group in a sample grouping is not limited to being contiguous samples and may contain non-adjacent samples. As there may be more than one sample grouping for the samples in a track, each sample grouping may have a type field to indicate the type of grouping. Sample groupings may be represented by two linked data structures: (1) a SampleToGroupBox (‘sbgp’ box) represents the assignment of samples to sample groups; and (2) a SampleGroupDescriptionBox (sgpd box) contains a sample group entry for each sample group describing the properties of the group. There may be multiple instances of the SampleToGroupBox and SampleGroupDescriptionBox based on different grouping criteria. These may be distinguished by a type field used to indicate the type of grouping. SampleToGroupBox may comprise a grouping_type_parameter field that can be used e.g., to indicate a sub-type of the grouping.

### Local Scaling Adaptation (LSA)

LSA is used as a compression tool in the NNC, in order to obtain a compact representation of the neural network by parameter reduction (FIG. 2, element 201). In particular, LSA is used for changing the weights of original neural network model. LSA may be used instead of or in addition to a batchnorm folding, which is also discussed in the NNC.

LSA aims at increasing the capacity of the neural network by introducing a multiplicative scaling factor to each output element (e.g., a tensor) of the linear component of a convolutional or fully-connected layer. That is, in the case of fully-connected layers, a unique scaling factor is multiplied to each output neuron before the bias is added. Analogously, at convolutional layers each output feature map is assigned a unique scaling factor which is multiplied to all elements of the feature map, before the bias is added respectively.

For this purpose, the computational graph of the neural network is adapted by introducing a multiplication function and a multi-dimensional parameter whose first dimension's size corresponds to the number of output elements of the preceding layer. The overall number of dimensions is equal to the preceding layer, but, except for the first dimension, they are of size 1 to allow for correct tensor multiplication. E.g., if a preceding convolutional layer is of shape (Cₒ, Cᵢ, K, K) with Cₒ being its output dimension, the scaling factor tensor has a shape of (Cₒ, 1, 1, 1).

Due to this process, the capacity of the network may be increased, and thus, the quantization error induced may be compensated by quantizing the weight tensors of the convolutional and fully-connected layers.

The scaling factor s can be present in NNR compressed payloads of type NNR_PT_BLOCK as output variable RecLS and they are quantized using either uniform quantization or dependent scalar quantization.

When batchnorm folding is applied together with local scaling adaptation, the scaling factors s are merged with parameter a of the batchnorm folding operation as follows:

$${α}^{′} = α ∘ s$$

The resulting variable α′ can be present in NNR compressed payloads of type NNR_PT_BLOCK as output variable RecLS and it is quantized using either uniform quantization or dependent scalar quantization.

Note that the decoder needs not to be aware of whether RecLS contains only folded batchnorm parameters or only scaling factors or both.

The recommended usage of the scaling factors is to derive and add them after quantization of the weight tensors has been performed (FIG. 2, element 202). The scaling factors are initialized with the value of 1, and then adapted by means of backpropagation so that the prediction performance of the quantized neural network is increased. Notably, this particular manner of introducing and calculating the scaling factors requires access to data. However, having access to only a small dataset usually suffices for attaining good results with this method, comparable to the size of a typical validation set (approx. 5% of the training set size).

In the scope of incremental compression of neural networks, the weight updates, i.e., the differences of the parameters trained further with respect to their previous state, are quantized (and not the weights themselves). Apart from the increased model capacity, this leads to different mechanisms of LSA taking effect within the scope of incremental compression: The local scaling of weight values compensates for incomplete (sparse) and/or low precision weight updates. Thus, LSA may not be applied only once, e.g. subsequently to weight quantization, but after each change of parameters.

The recommended usage of the LSA is to first train the network, e.g., for one epoch, over all training data samples. Second, the weight increments are sparsified and added on the prior model state. Third, only the scaling factors are trained utilizing (part of) the training samples, whereas the rest of the sparsely updated network is frozen, including running variances and means of the BatchNorm modules. From all iterations over the subset of samples (e.g. 5) of training scaling factors only, the best network in terms of validation performance is selected and proceeded with. If LSA does not improve model performance compared to the sparsely updated model, the scaling factor updates are discarded. Otherwise, the parameter differences of the model are recalculated (including the scaling factor parameters now) and encoded.

A learning rate schedule, e.g., a cosine annealing learning rate schedule with warm restarts, may be used, where restarts are introduced prior to training the scaling factors, e.g., after each main training epoch.

The presence and semantics of syntax elements for local scaling are specified in Table 2.

TABLE 2

| Syntax element/ | | |
|---|---|---|
| Variable | condition | semantics |
| compressed_ | (compressed_parameter_ | One bit |
| parameter_ | types && NNR CPT LS) | indicating whether |
| types | ! = 0 | a local scaling |
| | | parameter is |
| | | present |
| QpDensity | present | unsigned integer |
| Quantization- | present | integer |
| Parameter | | |
| qp_value | present | integer |
| dq_flag | present | flag |

Local Scaling Adaptation (LSA) aims to increase the capacity of neural network by learning a multiplicative scaling factor to each of the output element of the linear component of the convolutional or fully connected layer. The local scaling factor is multiplied before adding the bias. To this purpose, for instance, for a tensor (i.e., a convolutional layer) of size (Cₒ, Cᵢₙ, W, H), with Cₒ being its output channel dimension, the scaling factor has a shape of (C₀,1,1,1). Given the scaling factor it is applied on the output channel dimension on the convolutional layer output before any bias is added or activation function is applied.

Since LSA is initially designed to be employed to each output channel of a neural network weight matrix, e.g., a convolutional weight tensor or a fully connected weight tensor, the LSA is constrained to a specific dimension of the tensor, more specific, the last tensor dimension. According to present embodiments, LSA is employed for generic tensorial data, which expects employing the LSA to different axis of tensor than the last axis (which is equivalent to the output axis of a neural weight tensor).

It is also noticed, that the LSA has been initially designed to be determined via training of neural networks and is applied to each output channel of a neural network weight matrix. According to present embodiments, LSA is employed for generic tensorial compression.

Employing LSA for generic tensorial coding according to present embodiments may require that the scaling values may be pre-determined or an output of some learnt or statistical mechanism and more importantly the information about the axis which LSA is employed to is present at the decoder. That is, to be able to determine the axis in which LSA is employed, the present embodiments provide a signaling mechanism to indicate which axis is employed.

The present embodiments relate to signalling mechanisms such that LSA can be used for generic tensors. In addition, the present embodiments provide methods in which information on axis, which LSA has been employed on, is delivered to a neural decoder.

The present embodiments are discussed in more detailed manner in the following.

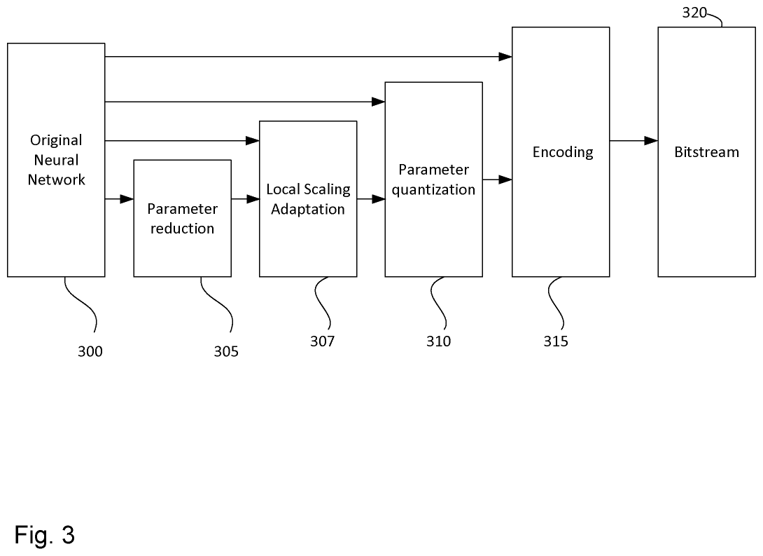

FIG. 3 illustrates a NNC encoding pipeline with the local scaling adaptation. The pipeline of FIG. 3 comprises the same elements as the one shown in FIG. 2. Thus, an original neural network 300 is first received, and preprocessing, such as parameter reduction 305, is carried out. The parameter reduction 305 may contain one of more of pruning, sparsification, decomposition, unification. The LSA 307 is applied to adjust the scaling of the parameters. According to present embodiments, the LSA is applied to a certain axis of the tensor. Then the parameters are quantized 310 after which the tensor with the quantized parameters (i.e., weights) is encoded 315 to produce a bitstream 320. In addition, according to present embodiments, information on which axis the LSA was employed to, is encoded to the bitstream.

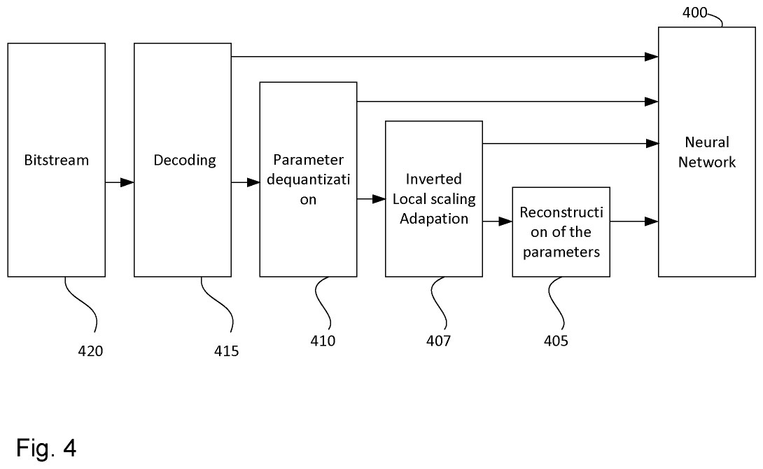

FIG. 4 illustrates a NNC decoding pipeline for the bitstream resulting from the NNE encoding pipeline. In the NNC decoding pipeline inverse steps are carried out to reconstruct the neural network. The process thus starts at receiving a bitstream 420, and decoding 415 tensors having the parameters (i.e., weights) from the bitstream. In addition, information concerning the LSA is decoded. Such information comprises an indication of an axis, to which the LSA is employed. After decoding the parameters (i.e., weights) of the tensor are dequantized 410, and inverse of the LSA 407 is applied to restore the original parameters. The parameters are reconstructed 405 to generate the neural network 400.

As discussed, the present embodiments provide signaling information from the encoder to the decoder on how to employ a local scaling adaptation mechanism (FIG. 3: 307; FIG. 4: 407) for the purpose of generic tensorial compression. This is achieved by the following:
In a situation, where LSA is employed only on first or last axis of any tensor:
   Encoding a flag into a bitstream to indicate the axis to be processed.
In a situation, where LSA is employed on any of the axis of a tensor:
   In option 1 using a bit-field or alternatively as an enumeration to indicate the axis;
   In option 2 encoding a particular axis number into a bitstream.

The purpose of employing the LSA on generic tensors, as in the present embodiments, is to obtain a compression friendly tensor and a smaller scaling vector that allows more efficient compression of a tensor. A compression friendly tensor is a tensor that has lower entropy or has elements that are close to a particular value (for example zero), which makes them easier to be handled in the rest of the pipeline within quantization or entropy coding steps. The compression friendly part may be compressed using any compression pipeline, such as quantization and entropy coding. And the smaller vector may be carried uncompressed or leveraging some advanced statistical approach. The axis information as discussed above can be indicated in the bitstream in one of the ways described below, which enables the decoder to properly decode any tensor data when LSA is employed.

### Embodiment 1: Axis Indicator Flag

When local scaling parameter is present, with the condition (compressed_parameter_types && NNR_CPT_LS) !=0, the NNR compressed data unit header is extended with a flag indicating the axis on which the scaling is applied. To enable applying the LSA on any axis, the Axis syntax element is introduced.

| Syntax element/ | | |
|---|---|---|
| Variable | condition | semantics |
| compressed_ | (compressed_parameter_ | One bit indicating |
| parameter_ | types && NNR_CPT_ | whether |
| types | LS) ! = 0 | a local scaling |
| | | parameter is |
| | | present |
| QpDensity | present | unsigned integer |
| Quantization- | present | integer |
| Parameter | | |
| qp_value | present | integer |
| dq_flag | present | flag |
| Axis | present | flag |

The Axis is defined to indicate which of the two presumed dimensions of a tensor is going to be decodable with the help of LSA.

In an instance, when coding a generic tensor T of shape (W1, W2, . . . Wn), when the axis flag is set to 0 the LSA parameters are defined by a tensor of shape (W1, 1, . . . 1) and are coded as a vector of share (W1). In another scenario, when the axis flag is set to 1, the LSA parameters are defined by a tensor of shape (1, W2, 1, . . . 1) and are coded as a vector of shape (W2).

On the decoder side after decoding the LSA parameters and the generic tensor T, the axis flag is checked and if the axis flag is decoded to be 0, a tensor of shape (W1, 1,1 . . . 1) is reconstructed from the decoded LSA parameters and multiplied to the tensor of shape (W1, W2 . . . Wn) and when the axis flag is decoded to be 1, a tensor of shape (1, W2, 1 . . . 1) is reconstructed from the decoded LSA parameters and multiplied to the decoded tensor T.

In an alternative embodiment, the generic tensor could be used to define the weights of the neural network, or its activations or a synthetically created tensor. In case when the tensor is defined by a convolutional layer of a neural network, the tensor may have a shape of (Co, Cin, W, H) and the LSA parameters are coded as a vector of size (Co) when the axis flag is set to 0, or coded as a vector of size (Cin) when the axis flag is set to 1. In case when the tensor is defined by a linear layer of the neural network, the tensor may have a shape of (Wo, Win) and the LSA parameters are coded as a vector of size (Wo) when the axis flag is set to 0 or coded as a vector of size (Win) when the axis flag is set to 1.

### Embodiment 2: Axis Number

When local scaling parameter is present, with the condition (compressed_parameter_types && NNR_CPT_LS) !=0, we extend the NNR compressed data unit header with a integer indicating the axis on which the scaling is applied.

| Syntax element/ | | |
|---|---|---|
| Variable | condition | semantics |
| compressed_ | (compressed_parameter_ | One bit indicating |
| parameter_ | types && NNR_CPT_ | whether a local |
| types | LS) ! = 0 | scaling |
| | | parameter is |
| | | present |
| QpDensity | present | unsigned integer |
| Quantization- | present | integer |
| Parameter | | |
| qp_value | present | integer |
| dq_flag | present | flag |
| Axis | Present | unsigned integer |

In one instance, when coding a generic tensor T of shape (W1, W2 . . . Wn), when the Axis Number is set to a value in [0, n−1], the LSA parameters are defined by a tensor of size n filled with ones except for the axis equal to the value of Axis Value. For instance, when a tensor T of shape (W1, W2, W3) and when the Axis Number is set to 2, then the LSA parameters are defined by a tensor of size 3 and shape (1,1, W3) and are coded as a vector of size (W3). On the decoder side after decoding the LSA parameters and the generic tensor T, the Axis Number is checked, when the Axis Number is decoded to be 2 and the LSA parameters are reconstructed to a tensor of size 3, with shape (1,1, W3), and the reconstructed LSA parameters are multiplied to the tensor T of shape (W1,W2,W3).

### Embodiment 3: Axis Indicator Enumeration

01181 When local scaling parameter is present, with the condition (compressed_parameter_types && NNR_CPT_LS) !=0, we extend the NNR compressed data unit header with a integer indicating the axis on which the scaling is applied.

| Syntax element/ | | |
|---|---|---|
| Variable | condition | semantics |
| compressed_ | (compressed_parameter_ | One bit indicating |
| parameter_ | types && NNR_CPT_ | whether a local |
| types | LS) ! = 0 | scaling |
| | | parameter is |
| | | present |
| QpDensity | present | unsigned integer |
| Quantization- | present | integer |
| Parameter | | |
| qp_value | present | integer |
| dq_flag | present | flag |
| Axis | Present | 8 bits indicating the |
| | | axis |

Here Axis is limited to at least 4 bit or 8 bits allowing to enumerate some of the most common dimensions, e.g., in case of 8-bit reservation, 0x0l indicates the input dimension as axis of interest, 0x02 indicates the output dimension as axis of interest and so on, and 0x03-0xFF reserved for other dimensions of interest to be defined.

In an alternative, embodiment the 8-bit could be used to mediate the number of axes of interest if the tensor sizes do not have more than 256 dimensions.

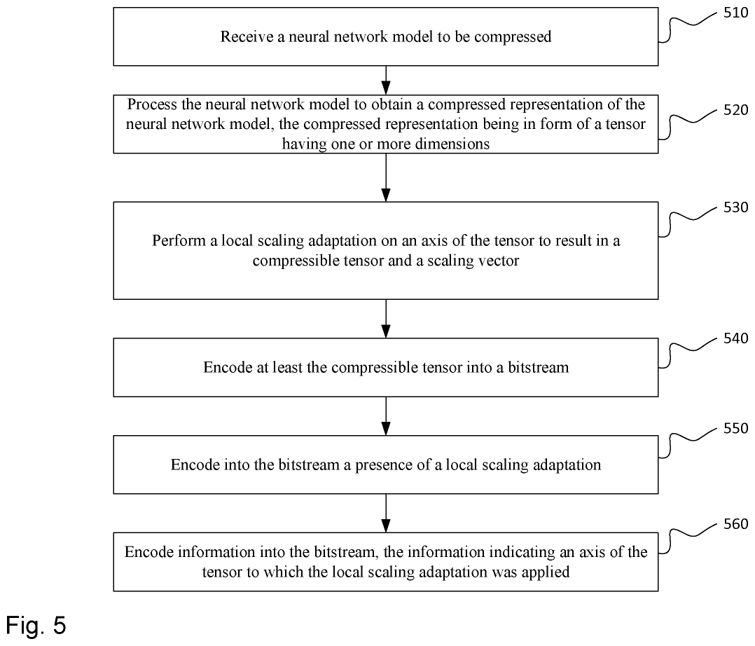

The method for encoding according to an embodiment is shown in FIG. 5. The method generally comprises receiving 510 a neural network model to be compressed; processing 520 the neural network model to obtain a compressed representation of the neural network model, the compressed representation being in form of a tensor having one or more dimensions; performing 530 a local scaling adaptation on an axis of the tensor to result in a compressible tensor and a scaling vector; encoding 540 at least the compressible tensor into a bitstream; encoding 550 into the bitstream a presence of a local scaling adaptation; and encoding 560 information into the bitstream, the information indicating an axis of the tensor to which the local scaling adaptation was applied. Each of the steps can be implemented by a respective module of a computer system.

An apparatus according to an embodiment comprises means for receiving a neural network model to be compressed; processing the neural network model to obtain a compressed representation of the neural network model, the compressed representation being in form of a tensor having one or more dimensions; performing a local scaling adaptation on an axis of the tensor to result in a compressible tensor and a scaling vector; encoding at least the compressible tensor into a bitstream; encoding into the bitstream a presence of a local scaling adaptation; and encoding information into the bitstream, the information indicating an axis of the tensor to which the local scaling adaptation was applied. Each of the steps can be implemented by a respective module of a computer system. The means comprises at least one processor, and a memory including a computer program code, wherein the processor may further comprise processor circuitry. The memory and the computer program code are configured to, with the at least one processor, cause the apparatus to perform the method of FIG. 5 according to various embodiments.

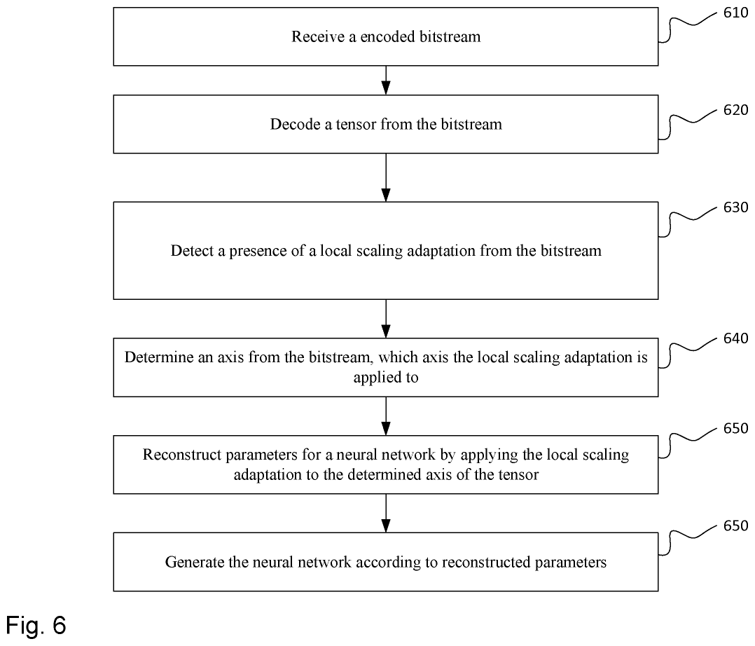

The method for decoding according to an embodiment is shown in FIG. 6. The method generally comprises receiving 610 a encoded bitstream; decoding 620 a tensor from the bitstream; detecting 630 a presence of a local scaling adaptation from the bitstream; determining 640 an axis from the bitstream, which axis the local scaling adaptation is applied to; reconstructing 650 parameters for a neural network by applying the local scaling adaptation to the determined axis of the tensor; and generating 660 the neural network according to the reconstructed parameters. Each of the steps can be implemented by a respective module of a computer system.

An apparatus according to an embodiment comprises means for receiving a encoded bitstream; means for decoding a tensor from the bitstream; means for detecting a presence of a local scaling adaptation from the bitstream; means for determining an axis from the bitstream, which axis the local scaling adaptation is applied to; means for reconstructing parameters for a neural network by applying the local scaling adaptation to the determined axis of the tensor; and means for generating the neural network according to the reconstructed parameters The means comprises at least one processor, and a memory including a computer program code, wherein the processor may further comprise processor circuitry. The memory and the computer program code are configured to, with the at least one processor, cause the apparatus to perform the method of FIG. 6 according to various embodiments.

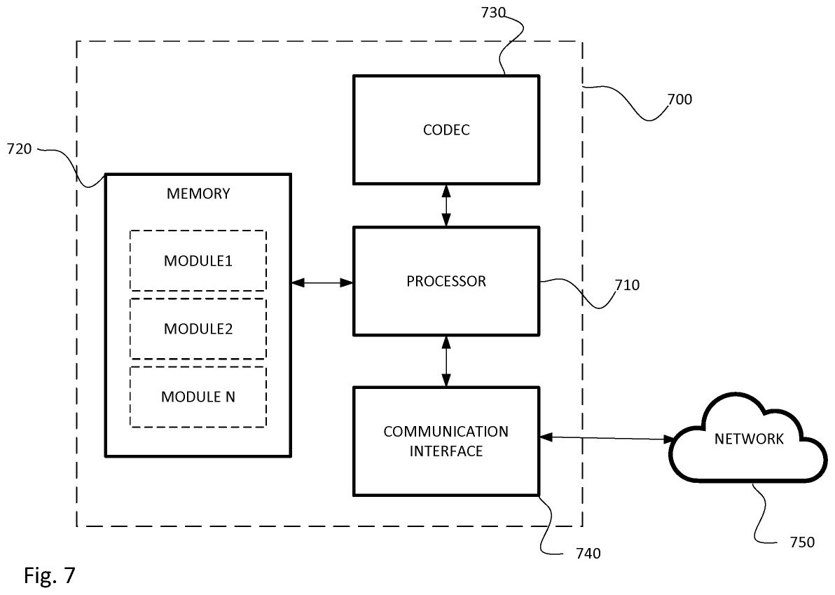

Embodiments of the present invention may be implemented in software, hardware, application logic or a combination of software, hardware and application logic. In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer, with one example of a computer described and depicted in FIG. 7. A computer-readable medium may comprise a computer-readable storage medium that may be any media or means that can contain or store the instructions for use by or in connection with an instruction execution system, apparatus, or device, such as a computer.

FIG. 7 illustrates an example of an electronic apparatus 700, being an example of video coding system where the present embodiments can be implemented. In some embodiments, the apparatus may be a mobile terminal or a user equipment of a wireless communication system or a camera device. The apparatus 700 may also be comprised at a local or a remote server or a graphic processing unit of a computer. The apparatus may also be comprised as part of a head-mounted display device.

The apparatus 700 comprises one or more processors 710 and one or more memories 720 and one or more transceivers interconnected through one or more buses. The one or more memories 720 store computer instructions, for example in respective modules (Module1, Module2, ModuleN). The one or more memories may store data in the form of image, video and/or audio data, and/or may also store instructions to be executed by the processors or the processor circuitry. The one or more processors may comprise a central processing unit (CPU) and/or a graphical processing unit (GPU). The one or more buses may be address, data or control buses, and may include interconnection mechanism, such as a series of lines on a motherboard or integrated circuit, fiber optics or other optical communication equipment. The apparatus also comprises a codec 730 that is configured to implement various embodiments relating to present solution. According to some embodiments, the apparatus may comprise an encoder or a decoder. The apparatus 700 also comprises a communication interface 740 which is suitable for generating wireless communication signals for example for communication with a cellular communications network, a wireless communications system, or a wireless local area network, and thus enabling data transfer over data transfer network 750.

The apparatus 700 may comprise a display in the form of a liquid crystal display. In other embodiments of the invention the display may be any suitable display technology suitable to display an image or video. The apparatus 700 may further comprise a keypad. In other embodiments of the invention any suitable data or user interface mechanism may be employed. For example, the user interface may be implemented as a virtual keyboard or data entry system as part of a touch-sensitive display. The apparatus 700 may comprise a microphone or any suitable audio input which may be a digital or analogue signal input. The apparatus 700 may further comprise an audio output device which in embodiments of the invention may be any one of: an earpiece, speaker, or an analogue audio or digital audio output connection. The apparatus 700 may also comprise a battery (or in other embodiments of the invention the device may be powered by any suitable mobile energy device such as solar cell, fuel cell or clockwork generator). The apparatus may further comprise a camera capable of recording or capturing images and/or video. The camera may be a multi-lens camera system having at least two camera sensors. The camera is capable of recording or detecting individual frames which are then passed to the codec 730 or to processor 710. The apparatus may receive the video and/or image data for processing from another device prior to transmission and/or storage.

The apparatus 700 may further comprise e.g., the other functional units disclosed e.g., in FIGS. 2-4 for implementing any of the present embodiments.

The apparatus may operate in a system, comprising multiple communication devices, which can communicate through one or more networks. The system may comprise any combination of wired or wireless networks including, but not limited to a wireless cellular telephone network (such as a GSM, UMTS, CDMA network etc.), a wireless local area network (WLAN) such as defined by any of the IEEE 802.x standards, a Bluetooth personal area network, an Ethernet local area network, a token ring local area network, a wide area network, and the Internet.

For example, the system can be a mobile telephone network enabling a connection to the internet. The connection can form, but is not limited to, long range wireless connections, short range wireless connections, and various wired connections including, but not limited to, telephone lines, cable lines, power lines, and similar communication pathways.

The example communication devices operating in the system may include, but are not limited to, an electronic device or apparatus, a combination of a personal digital assistant (PDA) and a mobile telephone, a PDA, an integrated messaging device (IMD), a desktop computer, a notebook computer, each of which can be a representative of the apparatus according to present embodiments. The apparatus according to present embodiments may be stationary or mobile when carried by an individual who is moving. The apparatus may also be located in a mode of transport including, but not limited to, a car, a truck, a taxi, a bus, a train, a boat, an airplane, a bicycle, a motorcycle, or any similar suitable mode of transport.

The apparatus may also be a set-top box; i.e. a digital TV receiver, which may/may not have a display or wireless capabilities, a tablet or (laptop) a personal computer (PC), which have hardware or software or combination of the encoder/decoder implementations, in various operating systems, or a chipset, processor, DSP and/or embedded system offering hardware/software based coding.

The apparatus according to present embodiments may send and receive calls and messages and communicate with service providers through a wireless connection to a base station. The base station may be connected to a network server that allows communication between the mobile telephone network and the internet.

The apparatus may communicate using various transmission technologies including, but not limited to, code division multiple access (CDMA), global systems for mobile communications (GSM), universal mobile telecommunications system (UMTS), time divisional multiple access (TDMA), frequency division multiple access (FDMA), transmission control protocol-internet protocol (TCP-IP), short messaging service (SMS), multimedia messaging service (MMS), email, instant messaging service (IMS), Bluetooth, IEEE 802.11 and any similar wireless communication technology. A communications device involved in implementing various embodiments of the present invention may communicate using various media including, but not limited to, radio, infrared, laser, cable connections, and any suitable connection.

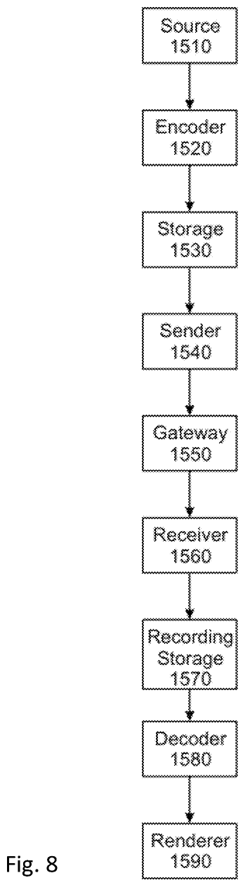

FIG. 8 is a graphical representation of an example multimedia communication system within which various embodiments may be implemented. A data source 1510 provides a source signal in an analog, uncompressed digital, or compressed digital format, or any combination of these formats. An encoder 1520 may include or be connected with a pre-processing, such as data format conversion and/or filtering of the source signal. The encoder 1520 encodes the source signal into a coded media bitstream. It should be noted that a bitstream to be encoded may be received directly or indirectly from a remote device located within virtually any type of network. Additionally, the bitstream may be received from local hardware or software. The encoder 1520 may be capable of encoding more than one media type, such as audio and video, or more than one encoder 1520 may be required to code different media types of the source signal. The encoder 1520 may also get synthetically produced input, such as graphics and text, or it may be capable of producing coded bitstreams of synthetic media. In the following, only processing of one coded media bitstream of one media type is considered to simplify the description. It should be noted, however, that typically real-time broadcast services comprise several streams (typically at least one audio, video and text sub-titling stream). It should also be noted that the system may include many encoders, but in the figure only one encoder 1520 is represented to simplify the description without a lack of generality. It should be further understood that, although text and examples contained herein may specifically describe an encoding process, one skilled in the art would understand that the same concepts and principles also apply to the corresponding decoding process and vice versa.

The coded media bitstream may be transferred to a storage 1530. The storage 1530 may comprise any type of mass memory to store the coded media bitstream. The format of the coded media bitstream in the storage 1530 may be an elementary self-contained bitstream format, or one or more coded media bitstreams may be encapsulated into a container file, or the coded media bitstream may be encapsulated into a Segment format suitable for DASH (or a similar streaming system) and stored as a sequence of Segments. If one or more media bitstreams are encapsulated in a container file, a file generator (not shown in the figure) may be used to store the one more media bitstreams in the file and create file format metadata, which may also be stored in the file. The encoder 1520 or the storage 1530 may comprise the file generator, or the file generator is operationally attached to either the encoder 1520 or the storage 1530. Some systems operate “live”, i.e. omit storage and transfer coded media bitstream from the encoder 1520 directly to the sender 1540. The coded media bitstream may then be transferred to the sender 1540, also referred to as the server, on a need basis. The format used in the transmission may be an elementary self-contained bitstream format, a packet stream format, a Segment format suitable for DASH (or a similar streaming system), or one or more coded media bitstreams may be encapsulated into a container file. The encoder 1520, the storage 1530, and the server 1540 may reside in the same physical device or they may be included in separate devices. The encoder 1520 and server 1540 may operate with live real-time content, in which case the coded media bitstream is typically not stored permanently, but rather buffered for small periods of time in the content encoder 1520 and/or in the server 1540 to smooth out variations in processing delay, transfer delay, and coded media bitrate.

The server 1540 sends the coded media bitstream using a communication protocol stack. The stack may include but is not limited to one or more of Real-Time Transport Protocol (RTP), User Datagram Protocol (UDP), Hypertext Transfer Protocol (HTTP), Transmission Control Protocol (TCP), and Internet Protocol (IP). When the communication protocol stack is packet-oriented, the server 1540 encapsulates the coded media bitstream into packets. For example, when RTP is used, the server 1540 encapsulates the coded media bitstream into RTP packets according to an RTP payload format. Typically, each media type has a dedicated RTP payload format. It should be again noted that a system may contain more than one server 1540, but for the sake of simplicity, the following description only considers one server 1540.

If the media content is encapsulated in a container file for the storage 1530 or for inputting the data to the sender 1540, the sender 1540 may comprise or be operationally attached to a “sending file parser” (not shown in the figure). In particular, if the container file is not transmitted as such but at least one of the contained coded media bitstream is encapsulated for transport over a communication protocol, a sending file parser locates appropriate parts of the coded media bitstream to be conveyed over the communication protocol. The sending file parser may also help in creating the correct format for the communication protocol, such as packet headers and payloads. The multimedia container file may contain encapsulation instructions, such as hint tracks in the ISOBMFF, for encapsulation of the at least one of the contained media bitstream on the communication protocol.

The server 1540 may or may not be connected to a gateway 1550 through a communication network, which may e.g. be a combination of a CDN, the Internet and/or one or more access networks. The gateway may also or alternatively be referred to as a middle-box. For DASH, the gateway may be an edge server (of a CDN) or a web proxy. It is noted that the system may generally comprise any number gateways or alike, but for the sake of simplicity, the following description only considers one gateway 1550. The gateway 1550 may perform different types of functions, such as translation of a packet stream according to one communication protocol stack to another communication protocol stack, merging and forking of data streams, and manipulation of data stream according to the downlink and/or receiver capabilities, such as controlling the bit rate of the forwarded stream according to prevailing downlink network conditions. The gateway 1550 may be a server entity in various embodiments.

The system includes one or more receivers 1560, typically capable of receiving, de-modulating, and de-capsulating the transmitted signal into a coded media bitstream. The coded media bitstream may be transferred to a recording storage 1570. The recording storage 1570 may comprise any type of mass memory to store the coded media bitstream. The recording storage 1570 may alternatively or additively comprise computation memory, such as random-access memory. The format of the coded media bitstream in the recording storage 2170 may be an elementary self-contained bitstream format, or one or more coded media bitstreams may be encapsulated into a container file. If there are multiple coded media bitstreams, such as an audio stream and a video stream, associated with each other, a container file is typically used and the receiver 1560 comprises or is attached to a container file generator producing a container file from input streams. Some systems operate “live,” i.e. omit the recording storage 1570 and transfer coded media bitstream from the receiver 1560 directly to the decoder 1580. In some systems, only the most recent part of the recorded stream, e.g., the most recent 10-minute excerption of the recorded stream, is maintained in the recording storage 1570, while any earlier recorded data is discarded from the recording storage 1570.

The coded media bitstream may be transferred from the recording storage 1570 to the decoder 1580. If there are many coded media bitstreams, such as an audio stream and a video stream, associated with each other and encapsulated into a container file or a single media bitstream is encapsulated in a container file e.g., for easier access, a file parser (not shown in the figure) is used to decapsulate each coded media bitstream from the container file. The recording storage 1570 or a decoder 1580 may comprise the file parser, or the file parser is attached to either recording storage 1570 or the decoder 1580. It should also be noted that the system may include many decoders, but here only one decoder 1580 is discussed to simplify the description without a lack of generality.

The coded media bitstream may be processed further by a decoder 1580, whose output is one or more uncompressed media streams. Finally, a renderer 1590 may reproduce the uncompressed media streams with a loudspeaker or a display, for example. The receiver 1560, recording storage 1570, decoder 1580, and renderer 1590 may reside in the same physical device or they may be included in separate devices.

A sender 1540 and/or a gateway 1550 may be configured to perform switching between different representations e.g. for switching between different viewports of 360-degree video content, view switching, bitrate adaptation and/or fast start-up, and/or a sender 1540 and/or a gateway 1550 may be configured to select the transmitted representation(s). Switching between different representations may take place for multiple reasons, such as to respond to requests of the receiver 1560 or prevailing conditions, such as throughput, of the network over which the bitstream is conveyed. In other words, the receiver 1560 may initiate switching between representations. A request from the receiver can be, e.g., a request for a Segment or a Subsegment from a different representation than earlier, a request for a change of transmitted scalability layers and/or sub-layers, or a change of a rendering device having different capabilities compared to the previous one. A request for a Segment may be an HTTP GET request. A request for a Subsegment may be an HTTP GET request with a byte range. Additionally, or alternatively, bitrate adjustment or bitrate adaptation may be used for example for providing so-called fast start-up in streaming services, where the bitrate of the transmitted stream is lower than the channel bitrate after starting or random-accessing the streaming in order to start playback immediately and to achieve a buffer occupancy level that tolerates occasional packet delays and/or retransmissions. Bitrate adaptation may include multiple representation or layer up-switching and representation or layer down-switching operations taking place in various orders.

In telecommunications and data networks, a channel may refer either to a physical channel or to a logical channel. A physical channel may refer to a physical transmission medium such as a wire, whereas a logical channel may refer to a logical connection over a multiplexed medium, capable of conveying several logical channels. A channel may be used for conveying an information signal, for example a bitstream, from one or several senders (or transmitters) to one or several receivers.

A decoder 1580 may be configured to perform switching between different representations e.g., for switching between different viewports of 360-degree video content, view switching, bitrate adaptation and/or fast start-up, and/or a decoder 1580 may be configured to select the transmitted representation(s). Switching between different representations may take place for multiple reasons, such as to achieve faster decoding operation or to adapt the transmitted bitstream, e.g. in terms of bitrate, to prevailing conditions, such as throughput, of the network over which the bitstream is conveyed. Faster decoding operation might be needed for example if the device including the decoder 1580 is multi-tasking and uses computing resources for other purposes than decoding the video bitstream. In another example, faster decoding operation might be needed when content is played back at a faster pace than the normal playback speed, e.g. twice or three times faster than conventional real-time playback rate.

In the above, some embodiments have been described with reference to and/or using terminology of HEVC and/or VVC. It needs to be understood that embodiments may be similarly realized with any video encoder and/or video decoder.

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

1. An apparatus comprising at least one processor; and at least one memory storing instructions that, when executed by the at least one processor, cause the apparatus to perform at least the following: receive a neural network model to be compressed; process the neural network model to obtain a compressed representation of the neural network model, the compressed representation being in form of a tensor having one or more dimensions; perform a local scaling adaptation on an axis of the tensor to result in a compressible tensor and a scaling vector; encode at least the compressible tensor into a bitstream; encode into the bitstream a presence of a local scaling adaptation; and encode information into the bitstream, the information indicating an axis of the tensor to which the local scaling adaptation was applied.

2. The apparatus according to claim 1, wherein the information indicates that the local scaling adaptation parameter is employed only on first axis or on last axis of a tensor.

3. The apparatus according to claim 2, further being caused to encode a flag into the bitstream to indicate an axis to be processed.

4. The apparatus according to claim 1, wherein the information indicates that the local scaling adaptation parameter is employed on any axis of a tensor.

5. The apparatus according to claim 4, further being caused to encode a number of the axis to be processed into the bitstream.

6. The apparatus according to claim 1, further being caused keeping the scaling vector uncompressed.

7. The apparatus according to claim 1, further being caused to send the bitstream to a decoder.

8. A method comprising at least: receiving a neural network model to be compressed; processing the neural network model to obtain a compressed representation of the neural network model, the compressed representation being in form of a tensor having one or more dimensions; performing a local scaling adaptation on an axis of the tensor to result in a compressible tensor and a scaling vector; encoding at least the compressible tensor into a bitstream; encoding into the bitstream a presence of a local scaling adaptation; and encoding information into the bitstream, the information indicating an axis of the tensor to which the local scaling adaptation was applied.

9. The method according to claim 8, wherein the information indicates that the local scaling adaptation parameter is employed only on first axis or on last axis of a tensor.

10. The method according to claim 9, further comprising: encoding a flag into the bitstream to indicate an axis to be processed.

11. The method according to claim 8, wherein the information indicates that the local scaling adaptation parameter is employed on any axis of a tensor.

12. The method according to claim 11, further comprising: encoding a number of the axis to be processed into the bitstream.

13. The method according to claim 8, further comprising: keeping the scaling vector uncompressed.

14. The method according to claim 8, further comprising: sending the bitstream to a decoder.

15. An apparatus comprising at least one processor; and at least one memory storing instructions that, when executed by the at least one processor, cause the apparatus to perform at least the following: receive an encoded bitstream; decode a tensor from the bitstream; detect a presence of a local scaling adaptation from the bitstream; determine an axis from the bitstream, which axis the local scaling adaptation is applied to; reconstruct parameters for a neural network by applying the local scaling adaptation to the determined axis of the tensor; and generate the neural network according to the reconstructed parameters.
